(19) United States
(12) Patent Application Publication
(10) Pub. No.: US 2004/0111368 A1
(43) Pub. Date: Jun. 10, 2004

(54) System and method for facilitating payment over the internet or like communication media

(76) Inventors: Luke A. Cuthbertson, Lowe Templestowe (AU); Shane F. Morris, Park Orchards (AU); Nicholas C. Langmaid, Keilor (AU)

Correspondence Address: Albert C Smith, Fenwich & West, Two Palo Alto Square, Palo Alto, CA, 94306, US

(21) Appl. No.: 10/296,612

(22) PCT Filed: May 25, 2001
(86) PCT No.: PCT/AU01/00605

(30) Foreign Application Priority Data
May 26, 2000 (AU) PQ 7774

(51) Int. Cl. G06F 17/60

(52) U.S. Cl. 705/40; 705/39; 705/26

(57) ABSTRACT

A system and method for permitting purchases over a communication medium such as the Internet is provided. A payment identifier (19) is produced when a purchaser (7) makes a purchase from a merchant (3). This payment identifier (19) is generated by a payment establishment (17). The payment identifier (19) is communicated to the purchaser (7). The purchaser (17) then takes the payment identifier (19) to a payment establishment (17) to make an in-person payment. The payment identifier (19) does not have to display in human readable form the identify of the merchant (3) or the goods or services purchased. When in-person payment is made at the payment establishment, the merchant (3) is advised, and the purchased goods or services can then be delivered by the merchant (3). The system and method takes away the uncertainty associated with making payment on-line by providing credit card or like details over the communication medium. The payment establishment (17) can be a respected organisation with whom purchases can feel comfortable with in so far as disclosing their credit card or like details. Typically the payment establishment (17) can be a Post Office.

This application is based on and claims the benefit of the filing date of Australian provisional application PQ7774filed 26 May 2000 and U.S. provisional application 60/241,336 filed 19 Oct. 2000.

### FIELD OF THE INVENTION

This invention relates a system and method for effecting payment over the Internet or like communication media. Throughout this specification the term Internet will be used but it should be understood that the term Internet is used to embrace electronic communication in general.

### DESCRIPTION OF PRIOR ART

Hitherto there have been many proposals for purchasing goods or services over the Internet. Most merchants require a purchaser to provide credit card details or other financial institution details to make the payment. Whilst such is not mandatory as cash or cheque is always acceptable, the use of credit card or other electronic payment system facilitates the rapid processing of the purchase because payment can be made on-line at the time of purchase.

Purchasers, on the other hand, are suspect of providing the necessary credit card or other financial institution details over the Internet because of the possibility of fraudulent use. On one hand “hackers” may be able to intervene the communication and obtain the credit card or financial institution details. On the other hand, the merchant who receives the details may not hold those details secure. Further, purchasers in general are reluctant to divulge personal information such as credit card details and the like because of the desire to maintain personal privacy. For some purchases anonymity is required, and the purchasers do not wish third parties to know what has been purchased or the name of the entity who will provide those purchases to the purchaser. In general, commerce via the Internet has been partly thwarted because of the above problems.

Some of the known proposals include:

The direct provision of a purchaser's bank account details to a merchant together with authority for the purchaser's bank to transfer money from the account to the merchant.

The direct provision of a purchaser's credit account details to a merchant together with an authority for the purchaser's credit supplier to accept any charges presented against the account by the merchant.

The provision of the purchaser's bank account or credit card details to a third party who then provides the purchaser with one or more personal codes that can be provided to a merchant and that authorises the third party to make payment on the purchaser's behalf and recover the payment from the purchaser's bank account or credit card.

The establishment of an account with a third party into which money can be paid by a variety of means. The details of this account can then be provided to a merchant authorising the third party to transfer money from the account to the merchant.

The purchase from a third party of a secure token that can be provided to the merchant as payment for goods and services. The merchant can subsequently use the secure token in a variety of ways, including presenting it to the third party and redeeming its value.

All of these schemes have limited applicability in the current marketplace because they suffer from one or more of the following:

The purchaser may be inconvenienced by the need to register in advance with a third party.

The purchaser may be inconvenienced by the need to make payments in advance to a third party.

The purchaser may be reluctant to divulge personal information, including bank account or credit account details, to a third party.

The purchaser may be reluctant to divulge personal information, including bank account or credit account details, to a merchant.

The merchant may lose sales because of the inconvenience to purchasers or the reluctance of purchasers to use the scheme.

### OBJECT AND STATEMENT OF THE INVENTION

The present invention therefore attempts to address the security problem associated with providing credit card or financial institution details via the Internet and the privacy anonymity issues associated therewith.

Therefore, according to a first broad aspect of the present invention there is provided a system for permitting purchases over a communications medium, said system including,

one or more merchant computers connected to the communications medium, one or more purchasers computers having access to the communications medium, one or more payment identifier generating computers connected to the communications medium, and one or more payment computers connected to the communications medium,

the merchant computers having software which can be accessed by the purchasers computers and from which a purchaser can be shown possible purchases,

the merchant computer having software having identifying means to identify that the purchaser has made a request to purchase whereupon the merchant software links the purchasers computer to said payment identifier generating computer and transfers data to the payment identifier generating computer, said data permitting the purchase to be identified by the merchant,

the payment identifier generating computer having software to generate an electronic payment identifier for the purchase from the data, and to transfer that payment identifier to the purchasers computer so the payment identifier can be taken to a payment establishment for in-person payment,

the payment establishment having a connection with said payment computer, so that when payment is made, the payment computer will be advised, said payment computer having software which will then enable the merchant to know that payment for the purchase has been made.

Preferably, the payment identifier generating computer transfers the payment identifier to the purchasers computer in a form suitable for the purchasers computer to print as a payment slip with the identifier theron. In one alternative embodiment the payment identifier computer produces a payment identifier in the form of transportable identifier in some convenient form other than a payment slip.

Preferably, the data which permits the purchase to be identified includes data of the amount of the purchase and data from which the identity of the merchant can be determined.

Preferably the printing of the payment slip includes printing of data of the amount of the purchase and data from which the identity of the merchant can be determined.

Preferably the data providing means includes means for publishing payment on a merchant accessible page via the communications medium.

Preferably the payment slip generating computer and the payment establishment are controlled by a single entity in a secure computer network environment.

Preferably the payment establishment transfers payment received to the merchant.

Preferably the transfer is directly to the merchants bank account by an electronic transfer of funds process initiated by completion of payment by the purchaser.

Preferably the payment establishment can receive payment by any one or more of cash, cheque, credit card or electronic funds transfer or other payment type.

Preferably the data providing means is computer linked with the data read by the payment establishment reading means to electronically post payment on the merchant accessible web page.

According to a further aspect of the invention there is provided a method to permit a merchant to know that payment for purchase requested by a user over a communications medium has been made, said method including,

on receiving at a merchants computer a request for purchase from a purchasers computer, connecting the purchasers computer to a payment identifier generating computer and also supplying purchase data to the payment identifier generating computer,

generating an electronic payment identifier at the payment identifier generating computer using the purchase data,

electronically transferring the payment identifier to the purchasers computer so it can be physically taken to a payment establishment for payment in-person,

receiving payment for the purchase at the payment establishment anid subsequently providing data to enable the merchant to know that payment for the purchase has been made.

For the purposes of this specification the term “purchases” is to embrace payment for any goods or services required.

### BRIEF DESCRIPTION OF THE DRAWINGS

In order that the invention can be more clearly ascertained examples of preferred embodiments will now be described with reference to the accompanying drawings wherein:

FIG. 1 is an overview functional diagram of the system and method of one example,

FIG. 2 is a functional diagram showing a merchant registration process where a government instrumentality such as a post office acts as the payment establishment of one particular embodiment, and

FIG. 3 is a functional flow diagram of the customer transaction process where the post office acts as the payment establishment in the same embodiment as in FIG. 2.

### DETAILED DESCRIPTION OF THE PREFERRED EMBODIMENTS

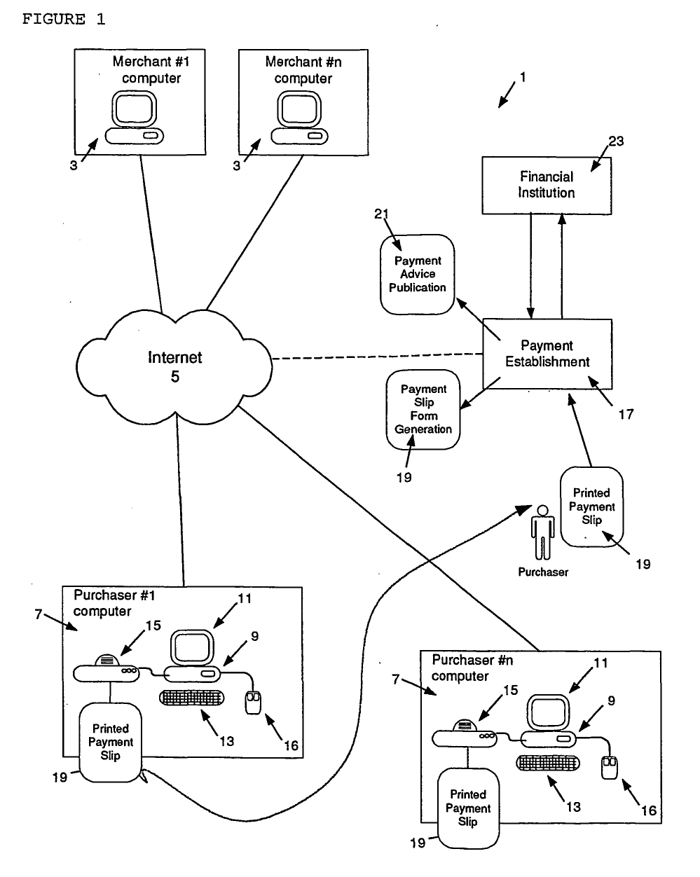

Referring firstly to FIG. 1 it can be seen that there is provided a communications medium 1 in the form of an Internet system. Here, merchants 1, . . . N have computers 3 or other appropriate computer communication devices connected with a communication system such as the Internet system 5.

A plurality of purchasers 1, . . . N computers 7 also connect with the Internet 5. Each of the purchasers computers 7 include a processor unit 9, a monitor screen 11, a keyboard 13, a printer 15, and a pointing device 16 such as a mouse.

The merchant computers 3 and the purchasers computers 7 communicate through the Internet 5 by means of appropriate service connections through a suitable service provider. These have been omitted from FIG. 1 to aid clarity.

Also connected to the Internet 5 is a payment establishment 17. The payment establishment 17 may be a single entity or may be composed of sub-entities. One of the duties of the payment establishment 17 is to receive in-person payments for goods or services purchased by the purchasers. These payments are on behalf of a respective merchant who is supplying goods or services to the purchasers. The payment establishment can receive payment in any convenient form such as cash, cheque, credit card, or electronic funds transfer and the like. Another duty of the payment establishment 17 is to generate a payment identifier 19, in an electronic form, which is provided to the purchasers on making a purchase and to be reproduced locally by the purchaser such as by printing or by other means. Another purpose of the payment establishment 17 is to publish payment advice 21. The payment advice may be in any convenient form such as electronic mail or a bulletin board or hard copy such as postal correspondence. The payment advice is preferably provided on a web page or bulletin board which can be accessed from the Internet 5 by merchants. The payment establishment 17 may be a single establishment or multiple establishments each performing the required duties. The payment establishment for the payment part of the duties is preferably an establishment with which purchasers have respect in so far as providing payment for the goods or services to be purchased. In the preferred example, the payment establishment 17 is typically a post office authority but may be any other nationally widely distributed organisation such as a bank, food store or the like with outlets widely distributed. By having the payment establishment 17 with a widely distributed chain of outlets, the purchaser requiring to make a payment will generally not have far to travel to physically present themselves to the payment establishment 17 to make a payment in-person. The payment establishment 17 may have electronic links to financial institutions 23 so that credit card or EFTPOS monetary transactions can be made when a person attends the payment establishment 17 and requires to make payment. In this way, credit card or direct debit payment can be made from the payment establishment 17.

The system described in FIG. 1 operates in the following way. Merchants who wish to participate in the system and method provide a home page on the Internet. Typically, merchants must be approved by the payment establishment 17 prior to participating. Detail of this will be explained shortly. The purchasers use their computers 7 to access required merchants home pages via the Internet 5. The purchasers computers have the usual browser software provided therein. The merchants computers have the usual web page software therein plus additional software that will permit transfer of purchase data and merchant identifying data to the payment establishment 17. The merchants computers also contain further software which is activated when a purchaser indicates that a required good or service is to be purchased from a particular merchant. In other words, when the purchaser views an appropriate item on the merchants home page and processes a signal such as by clicking a mouse to indicate that the particular goods or services are to be purchased, that software links the purchasers computer 7 to the payment establishment 17. At the same time, the software in the merchants computer transfers the purchase data and the merchant identify data to the payment establishment 17.

The payment establishment 17 has software resident in its server computer or other computer device which receives the purchase data and the merchant identity data and generates a payment identifier. In this example of the invention this payment identifier can be for a hard copy payment slip, to be printed by the purchasers printer 15. Thus, the computer device at the payment establishment 17 which generates the payment identifier can be referred to a payment identifier generating computer. The payment identifier generating process is electronic and the payment slip is electronically dispatched from the payment identifier generating computer at the payment establishment 17 to the purchasers computer. This payment identifier may be viewed on the monitor 11 of the purchasers computer to check the purchase information, merchant information and the like. In some embodiments it may be readily readable by the purchaser to decipher the purchase details. In other embodiments it may be a number or a code word and not readable by the purchaser to decipher the purchase details. This process occurs in a transparent fashion to the purchaser 7 so that as far as the purchaser 7 is concerned, the purchaser has merely indicated the desire to make a purchase by clicking an appropriate icon on the like, or by some other means, and the merchants computer 3 links the purchasers computer 7 to the payment establishment 17 so that the payment identifier 19, appears at the purchasers computer 7 on the monitor.

When the purchaser is aware that the payment identifier is provided at the purchasers computer 7, such as by viewing it on the monitor screen 11, the purchaser, in one embodiment, will be required to reproduce the identifier by printing a payment slip form 19 through the printer 15 locally at the purchasers premises. In other embodiments, the purchaser may be required to write the identifier down or memorise the identifier. In another embodiment the payment identifier may be recorded on a portable memory such as a floppy disk or the like. In all these alternative embodiments the payment identifier is then in a transportable form.

In order for the purchase to be transacted to conclusion, the purchaser must then take the payment identifier 19 physically to the payment establishment 17 for payment in-person. The payment establishment 17 then receives the payment identifier 19 and extracts data from the payment identifier 19 which can be used either directly or indirectly to associate the payment with the required merchant and purchase. In one embodiment, the printed payment slip may have a barcode printed thereon which identifies the merchant and the purchase. In other examples, a code can be utilised which can be matched with data held at the payment establishment 17 concerning the purchase, so that when matched, the payment establishment will electronically be able to determine which merchant and what purchase is involved. Other variations of providing data in the payment identifier 19 and matching the required purchase with the payment identifier and the purchase are also possible without departing from the invention.

When the person arrives at the payment establishment 17, and the payment identifier 19 is presented to a cashier, payment may be made in one of the various forms acceptable by the payment establishment such as cash, cheque, credit card or electronic funds transfer or the like. In the case of cheque transfer, there may be several days wait in order that the cheque is cleared before the payment establishment can determine that payment has been made. In the case of credit card transactions or EFTPOS transactions, the purchaser has the security of knowing and trusting the payment establishment with credit card details or electronic pin numbers and/or the like which may be needed to effect the payment transfer. In the case of cash payment, the purchaser knows that the payment will be applied directly to the purchase intended. A payment receipt may be generated by the payment establishment 17 so that the customer has proof of payment.

Typically, the barcode will be printed on the payment slip at the time of printing the payment slip, and the payment establishment 17 will have a barcode reader device which will read the barcode to extract the necessary data to identify the purchase. If the payment identifier 19 is written down by the purchaser or memorised by the purchaser, or copied to a portable memory device such as a floppy disk, it may be keyed into an input device by the purchaser or otherwise entered into the payment computer. Once payment has been made, the payment establishment 17 then electronically processes that payment has been made, and has data providing means which will enable the merchant to know that payment for the purchase has been made.

Typically, the data providing means provides data to a web page such as a bulletin board type web page which can be accessed by merchants. Thus, merchants can periodically access the bulletin board to determine when payment has been received by the payment establishment so that the merchant can then deliver the goods or services purchased. In alternative embodiments, the payment establishment 17 may directly inform the merchants that the purchase has been made. This may be by e-mail postings through the Internet or by some other electronic means. One other means may involve the physical dispatch of normal paper mail correspondence to the merchant. In another embodiment, the payment establishment may apply an appropriate image or other marking such as code marking to the payment slip when payment is made, and the purchaser may then post the payment slip to the merchant and the merchant can then process that slip to determine payment has been made. The bulletin board publication of purchase is a preferred option.

It can therefore be seen from the system outlined above, that a purchaser does not have to provide credit card or EFTPOS financial transaction data over the Internet. Thus, commerce conducted using the broad principles outlined herein should overcome the shortcomings of the known purchase systems where the credit card or EFTPOS transaction financial data needs to be provided over the Internet, which some people find insecure or do not trust. Further the purchase can be private in the sense that the person receiving payment at the payment establishment does not know what has been purchased and from whom the purchase has been made, as the payment identifier 19 need not reflect this information in easily human readable form.

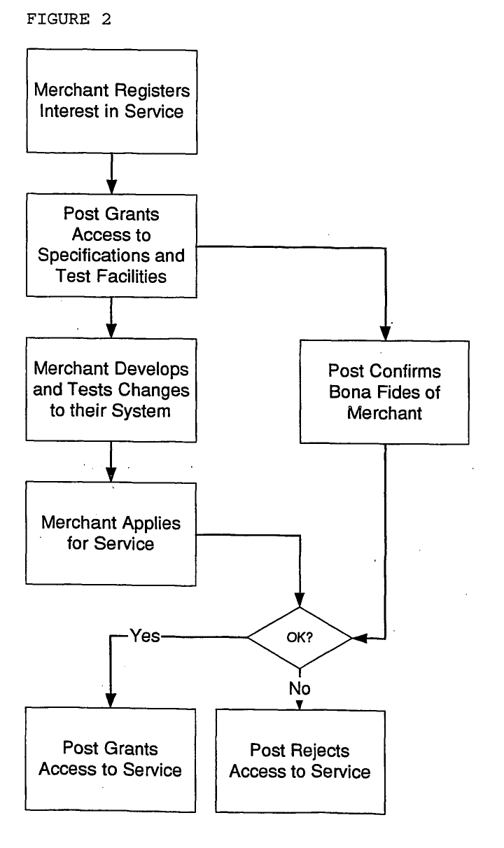

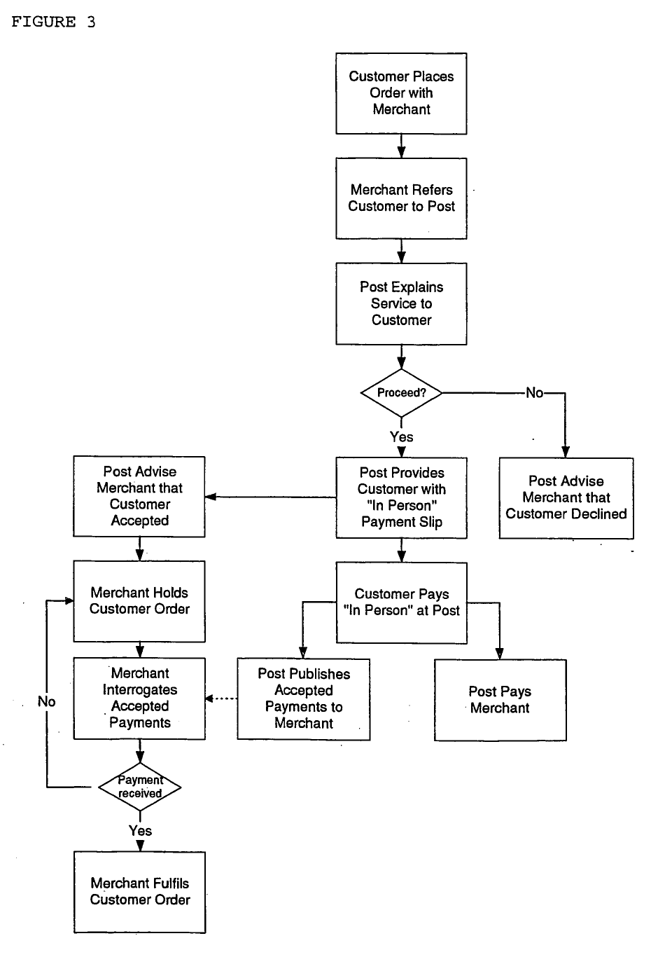

FIGS. 2 and 3 will now be described in relation to a post office being used as the payment establishment 17. Thus, through out the description which follows, the term “Post” will b referred to meaning the post office. As explained previously, the post office is one example of a payment establishment. The post office has particular flexibility in the proposed system when acting as a payment establishment 17 as the post office has many outlets throughout a given country. Thus, persons wishing to make payment will have local post offices to which payments can be made. Other payment establishments can be utilised. In addition, the various functions performed by the payment establishment 17 can be broken down into separate functions and performed at remote locations within the payment establishment 17. For example, in the case of a post office, there may be a central processing department that provides information for the payment identifier 19 to be generated. There may be a further separate department for receiving payments made by purchasers. In addition, there may be a further department for providing data which will enable a merchant to know that a payment has been made. Each of these may have its own dedicated computer for this purpose and there may be a link back to a server computer at the payment establishment 17 whereby remote computers for the required functions can locally process the required functions and then pass information back to the server computer which handles the actual Internet transactions between the merchant and the purchaser.

The business service has two major processes:

1. The merchant registration process, which provides rapid acceptance or rejection of an application by a merchant to use the service. This is achieved by asking a potential merchant to complete an on-line “registration of interest” form. Receipt of the registration of interest by Post automatically grants access to the service specifications and a test facility. It also initiates Post's legal and commercial checks on the acceptability of the potential merchant to use the service. Because these business operations are performed in parallel, Post is able to provide a rapid response when the potential merchant completes their evaluation and applies to use the service.

2. The customer transaction process, supports in-person payment by using an Internet web site to capture information from both merchant and consumer. It then provides the customer with information for a printed payment slip that can be presented with the payment at any Post retail outlet. The printed slip contains a dynamically generated barcode, and all of the information needed by Post to accept the payment and rapidly advise the merchant.

Both processes emphasise the use of a self-service approach over the Internet to keep administration costs to a minimum.

These processes are described in greater detail hereinafter.

1. Merchant Registration Process.

This process consists of business operations shown in FIG. 2:

Merchant Registers Interest in Service

Post's Internet web site will contain information about the In-Person payment acceptance service and its benefits. Potential merchants will be encouraged to complete a form on the web site to register their interest in using the service.

Post Grants Access to Specifications and Test Facilities.

As soon as a potential merchant has registered their interest in the service and provided contact information, they are automatically and immediately given access to service specifications and a test web site that allows them to try the service and to view a demonstration of the service.

Merchant Develops and Tests Changes to their System.

Potential merchants may use the service specifications to evaluate the service and also to develop and test the changes needed to their own web sites and business processes. All screens and reports produced from the test system are clearly marked to show that the information is for testing purposes only and has no monetary value.

Post Confirms Bona Fides of Merchant.

Once a potential merchant has registered interest in the service, Post can choose when to start the process of confirming the bona fides of the potential merchant. This might, for example, include verifying that the applicant has the right to use the trading names provided in the application.

Merchant Applies for Service.

When a potential merchant has reached the conclusion that they wish to use the service, they need to visit the web site again to formally apply, to accept Post's terms and conditions, and to provide details of the bank account that will be used for receiving payments.

Post Grants Access to Service

If Post accepts an application by a potential merchant to use the service, then the service database is adjusted to allow access to the merchant. At the same time, the merchant is registered in Post's other commercial systems, so that payments accepted on their behalf can be passed to them, and so that they can be charged service fees and commissions. When these steps have been completed, the merchant is formally advised that the service is available for their use.

Post Rejects Access to Service

Alternatively, if Post determines that a potential merchant should not be granted access to the service, this decision would normally be communicated to the applicant.

2. Customer Transaction Process.

This process consists of the business operations shown in FIG. 3:

Customer Places Order with Merchant

The process starts with a customer selecting the goods or service they wish to purchase from a merchant's Internet web site or call centre. The details vary between individual merchants, but typically one of the last steps will be to present the customer with a web page that allows a choice of payment options.

Merchant Refers Customer to Post

A merchant that uses Post's “In-Person” payment system will provide a link from their payment web page to the appropriate page on the Post's web site. Clicking on the link causes the customer's web browser to display the page from the Post's web site, and also passes parameters needed by Post to service the request, including the merchant identity, an order reference, the transaction value, the date until which the order remains valid, and the acceptable means for payment.

Post Explains Service to Customer

The Post web site will contain material that briefly explains the service to the customer and includes links to detailed terms and conditions, to ensure that the customer is familiar with the service offered.

Post Provides Customer with “In-Person” Payment Slip.

The Post web site also prepares the image of a “payment slip” that the customer must print and present to Australia Post along with the payment. The payment slip includes a reference number, payment identifier 19, that can be used by Post to retrieve all of the other information provided by the merchant about the payment. The payment slip is barcoded for rapid and efficient processing at Post's retail outlets. The barcode is dynamically generated and is specific to the Post EPOS system.

Post Advise Merchant that Customer Accepted.

If the customer clicks the link on Post's web page that indicates an intention to proceed with the use of the service, then Post returns the customer's web browser to a location on the merchant's web site that indicates acceptance.

Merchant Holds Customer Order

When a customer accepts the use of the “In-Persons” payment service, the merchant will normally wish to place the customer's order on hold until payment has been received by Post.

Post Advise Merchant that Customer Declined.

Alternatively, if the customer clicks the link on Post's web page that indicates a return to the merchant's web site without taking up the Post service, then Post returns the customer's web browser to a location on the merchant's web site that indicates that the customer has declined to pay by this method.

Customer Pays “In-Person” at Post

The customer will bring the payment slip into any Post retail outlet, where it will be recorded and the customer's payment collected. Post will take advantage of its existing highly efficient processes for accepting payments using point-of-sale computer systems and barcoding technology.

Post Publishes Accepted Payments to Merchant.

Payments accepted by Post will be recorded in a database and made available to merchants through the Post Internet web site. Payments such as cheques that involve a clearance period will be held until the clearance period has expired.

Merchant Interrogates Accepted Payments

On supplying a log-on and password, merchants will be able to review the list of payments received or expected from their customers, and determine the status of each. This will occur via a secure link.

Merchant Fulfils Customer Order.

Once the merchant has noted that payment has been received by Post, then the merchant may resume processing of the customer's order. If the order was held, the merchant may now provide the goods or services to the customer. The customer may also be informed at this point in time by an em-mail to the customer's e-mail address.

Post Pays Merchant.

Using net settlement, Post will regularly transfer the value of accepted payments, less any fees defined by the terms and conditions of service, to the merchant. This will typically occur by direct bank transfer.

Modifications may be made to the invention as would be apparent to persons skilled in the art of conducting commerce over the Internet and for making payments. For example the payment identifier 19 may be some code which is displayed on the computer monitor screen 11, and memorised and taken to the payment establishment where it can be entered to identify the payment and purchase. Alternatively, the payment identifier 19 may be recorded on a memory medium such as a floppy disk or the like and taken to the payment establishment where it can be read to identify the payment and purchase. In both cases privacy to the purchasers can be maintained as the payment establishment will not be able to read the payment identifier to determine the nature of the goods or services in the purchase nor the entity from which the purchase has been made. Further, the payment identifier 19 may include an expiry date by which payment must be made to ensure completion of the purchase. This will be provided to protect the merchant in the case of any price rises or shortage or complete sale of the goods or services in the purchase. Further, the payment identifier 19 may include an exclusion for one or more types of payments, such as particular credit card use or the like, in order to provide a degree of protection for the merchant against known high cost associated with some methods of payment.

These and other modifications may be made without departing from the ambit of the invention the nature of which is to be determined from the a foregoing description.

The claims defining the invention are as follows:

1. A system for permitting purchases over a communications medium, said system including,
one or more merchant computers connected to the communications medium, one or more purchasers computers having access to the communications medium, one or more payment identifier generating computers connected to the communications medium, and one or more payment computers connected to the communications medium,
the merchant computers having software which can be accessed by the purchasers computers and from which a purchaser can be shown possible purchases,
the merchant computer having software having identifying means to identify that the purchaser has made a request to purchase whereupon the merchant software links the purchasers computer to said payment identifier generating computer and transfers data to the payment identifier generating computer,
the payment identifier generating computer having software to generate an electronic payment identifier for the purchase from the data, said data identifying the merchant and the purchase, and to transfer that payment identifier to the purchasers computer so the payment identifier can be physically taken by the purchaser outside of the communications medium connection to remote a payment establishment for remote in-person payment,
the payment establishment being able to read the payment identifier, and having a communication medium connection with said payment computer, so that when payment is made, the payment computer will be advised, said payment computer having software which will then enable the merchant to know that payment for the purchase has been made.

2. A system as claimed in claim 1 wherein the payment identifier generating computer transfers the payment identifier to the purchasers computer in a form suitable for the purchasers computer to print as a payment slip with the payment identifier thereon.

3. A system as claimed in claim 1 wherein the data which permits the purchase to be identified includes data of the amount of the purchase and data from which the identity of the merchant can be determined.

4. A system as claimed in claim 2 wherein the printing of the payment slip includes printing of data of the amount of the purchase and data from which the identity of the merchant can be determined.

5. A system as claimed in claim 1 wherein the data providing means includes means for publishing payment on a merchant accessible page via the communications medium.

6. A system as claimed in claim 1 wherein the payment identifier generating computer and the payment establishment are controlled by a single entity in a secure computer network environment.

7. A system as claimed in claim 1 wherein the payment establishment transfers payment received to the merchant.

8. A system as claimed in claim 7 wherein the transfer is directly to the merchants bank account by an electronic transfer of funds process initiated by completion of payment by the purchaser.

9. A system as claimed in claim 1 wherein the payment establishment can receive payment by any one or more of cash, cheque, credit card or electronic funds transfer or other payment type.

10. A system as claimed in claim 1 wherein a data providing means is computer linked with the data read by the payment establishment reading means to electronically post payment on the merchant accessible web page.

11. A system as claimed in claim 1 wherein the payment identifier computer produces a payment identifier in the form of transportable identifier in some convenient form other than a payment slip.

12. A method to permit a merchant to know that payment for a purchase requested by a user over a communications medium has been made, said method including,
on receiving at a merchants computer a request for purchase from a purchasers computer, connecting the purchasers computer to a payment identifier generating computer and supplying merchant and purchase data to the payment identifier generating computer,
generating an electronic payment identifier at the payment identifier generating computer using the merchant and_purchase data,
electronically transferring the payment identifier to the purchasers computer so it can be physically taken by the purchaser outside of the communications medium connection to a remote payment establishment for remote payment in-person,
receiving payment for the purchase at the payment establishment, and
subsequently providing data to enable the merchant to know that payment for the purchase has been made.
